(19) United States
(12) Patent Application Publication
(10) Pub. No.: US 2002/0087705 A1
(43) Pub. Date: Jul. 4, 2002

(54) System and method for managing contracts

(76) Inventor: Brian Frank Smyth, Wembley (AU)

Correspondence Address: Laurie Ebling Simonelli, BLISS McGLYNN, P.C., Suite 600, 2075 West Big Beaver Road, Troy, MI, 48084, US

(21) Appl. No.: 09/752,181

(22) Filed: Dec. 29, 2000

(51) Int. Cl. G06F 15/173; G06F 15/16

(52) U.S. Cl. 709/229; 709/225

(57) ABSTRACT

A contract management system accessible by a plurality of users is disclosed, which has a data store containing user data and project data, said user data including, for each user, a user-type identifier indicating whether said user is a contract manager, client, clerical support or a consultant; project control means accessible by a contract manager to create project data for a project, said project data including an indication of user data for a consultant engaged under contract for the project, and deliverables data corresponding to deliverables to be provided under said contract, and financial data for said project; said project control means being accessible by the consultant to submit financial data for a project which the consultant is engaged on, and to submit variations to said financial data for a said project; said project control means being further accessible by said contract manager for a project to authorise said variatons to the financial data for that project and to authorise payment to the consultant in accordance with the financial data.

### FIELD OF THE INVENTION

This invention relates to a system and method for managing contracts. The invention has particular, although not exclusive, utility in relation to a contract management system accessible over a wide area network of computers such as the Internet.

### BACKGROUND ART

Contracts are used in almost all areas of commerce. Contracts associated with large projects, such as capital works projects are typically overseen by a contract manager. A consultant is engaged under contract to design, document and administer the construction of the building. The consultant may be appointed as Superintendents Representative to value the quantity and value of work done during the project and to ensure that deliverables required under the contract are provided. The consultant is also responsible for providing Project Progress Reports along with budget, cash flow and program reports. The client is billed on estimated monthly cash flows.

The contract manager is responsible for approving consultant fee claims.

Automated systems for managing contracts have not been widely used, and consequently managing such contracts has largely been a manual task where the efficiency of the contract management is largely dependent upon the skill of the contract manager.

Although applications for project management such as automated Gantt chart creation exist and are widely used, such applications do not facilitate the management of contracts as part of the project.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of this invention, there is provided a computer program stored on a computer readable media which, when executed on a computer, performs method steps for managing a contract, said method steps comprising:

storing, for each of a plurality of users, user data including a user-type identifier indicating whether said user is a contract manager or a consultant;

receiving from a contract manager information concerning a project and creating therefrom project data for a project, said project data including an indication of user data for a consultant engaged under contract for the project, deliverables data corresponding to deliverables to be provided under said contract, and financial data for said project;

receiving from the consultant financial data for a project which the consultant is engaged on, and storing said financial data as part of the project data for that project;

receiving from the consultant variations to said financial data for a project which the consultant is engaged on, notifying the contract manager of said variations, and upon receiving authorisation from the contract manager, storing said variations to the financial data in the project data for that project and to authorise payment to the consultant in accordance with the financial data.

Preferably, the method further comprises the step of receiving a fee claim from the consultant, notifying the contract manager of said fee claim, and upon receiving authorisation from the contract manager, approving payment to the consultant. More preferably, the method further comprises the step of not permitting the consultant to amend the financial data after a payment has been approved, but continuing to allow variations.

Preferably, said user-type identifier includes a contractor user-type, said step of producing project data includes producing an indication of user data for a contractor engaged under contract for the project, deliverables data corresponding to deliverables to be provided under said contract.

Preferably, said method further comprises the step of maintaining at least one insurance due date concerning a consultant and/or contractor relating to said project, sending reminder notices to the contract manager and to the consultant and/or contractor a predetermined time before the expiry of any said insurance due date, Preferably, the method further comprises the step of rejecting fee claims if any insurance due dates pass.

Preferably, the method further comprises the step of receiving a list of report headings from the contract manager and storing said list in the project data, and upon request from the consultant, presenting a status report to the consultant including the report headings and providing means for the consultant to enter information adjacent each report heading.

In accordance with a second aspect of this invention, there is provided a contract management system accessible by a plurality of users, comprising:

a data store containing user data and project data, said user data including, for each user, a user-type identifier indicating whether said user is a contract manager or a consultant;

project control means accessible by a contract manager to create project data for a project, said project data including an indication of user data for a consultant engaged under contract for the project, and deliverables data corresponding to deliverables to be provided under said contract, and financial data for said project;

said project control means being accessible by the consultant to submit financial data for a project which the consultant is engaged on, and to submit variations to said financial data for a said project;

said project control means being further accessible by said contract manager for a project to authorise said variations to the financial data for that project and to authorise payment to the consultant in accordance with the financial data.

Preferably, the project control means is arranged to receive a fee claim from the consultant, and in response thereto, to notify the contract manager of said fee claim, and upon receiving authorisation from the contract manager, to approve payment to the consultant.

Preferably, the project control means is arranged to not permit the consultant to amend the financial data after a payment has been approved, but to continue to receive variations.

Preferably, said user-type identifier includes a contractor user-type, and said project data includes an indication of user data for a contractor engaged under contract for the project, and deliverables data corresponding to deliverables to be provided under said contract.

Preferably, said project data includes at least one insurance due date concerning a consultant and/or contractor relating to said project, wherein said project control means is arranged to send reminder notices to the contract manager and to the consultant and/or contractor a predetermined time before the expiry of said insurance due date.

Preferably, the project control means is arranged to reject fee claims from the consultant if any insurance due dates pass.

Preferably, the project control means is arranged to receive a list of report headings from the contract manager and store said list in the project data, and upon request from the consultant to present a status report to the consultant including the report headings and provide means for the consultant to enter information adjacent each report heading.

Preferably, the means for the consultant to enter information comprise text entry boxes. More preferably, the project control means is arranged to populate said text entry boxes with information previously submitted by the consultant.

### BRIEF DESCRIPTION OF THE DRAWINGS

The invention will now be described, by way of example, with reference to one embodiment thereof and the accompanying drawings, in which:

FIG. 1 shows the contract management system of the embodiment in use;

FIG. 2 shows the configuration of the contract management system of FIG. 1;

FIGS. 3A and 3B show a project screen of the contract management system of FIG. 1;

FIG. 4 shows a datasheet administration screen of the contract management system of FIG. 1;

FIGS. 5A and 5B show a datasheet screen of the contract management system of FIG. 1;

FIGS. 6A and 6B show a contract screen of the contract management system of FIG. 1;

FIG. 6C shows a contract checklist screen of the contract management system of FIG. 1;

FIGS. 7A and 7B show a further contract screen of the contract management system of FIG. 1;

FIG. 8 shows a project screen of the contract management system of FIG. 1;

FIG. 9 shows an associated documents screen of the contract management system of FIG. 1;

FIG. 10 shows a project progress report screen of the contract management system of FIG. 1;

FIG. 11 shows a consultant contract screen of the contract management system of FIG. 1;

FIG. 12 shows a fee claim screen of the contract management system of FIG. 1;

FIG. 13 shows a progress fee claim screen of the contract management system of FIG. 1:

FIG. 14 shows a progress claim screen of the contract management system of FIG. 1;

FIG. 15 shows a fee variation screen of the contract management system of FIG. 1;

FIG. 16 shows a contract checklist screen of the contract management system of FIG. 1;

FIG. 17 shows a further consultant contract screen of the contract management system of FIG. 1;

FIG. 18 shows a payment certificate screen of the contract management system of FIG. 1;

FIG. 19 shows a variations screen of the contract management system of FIG. 1; and

FIG. 20 shows a consultant checklist screen of the contract management system of FIG. 1.

### BEST MODE(S) FOR CARRYING OUT THE INVENTION

The embodiment will be described with reference to a contract management system suitable for use with capital works projects. It should be appreciated, however, that the scope of the invention is not limited to contracts for capital works projects and that the invention is applicable in other areas whether contract management is desirable,

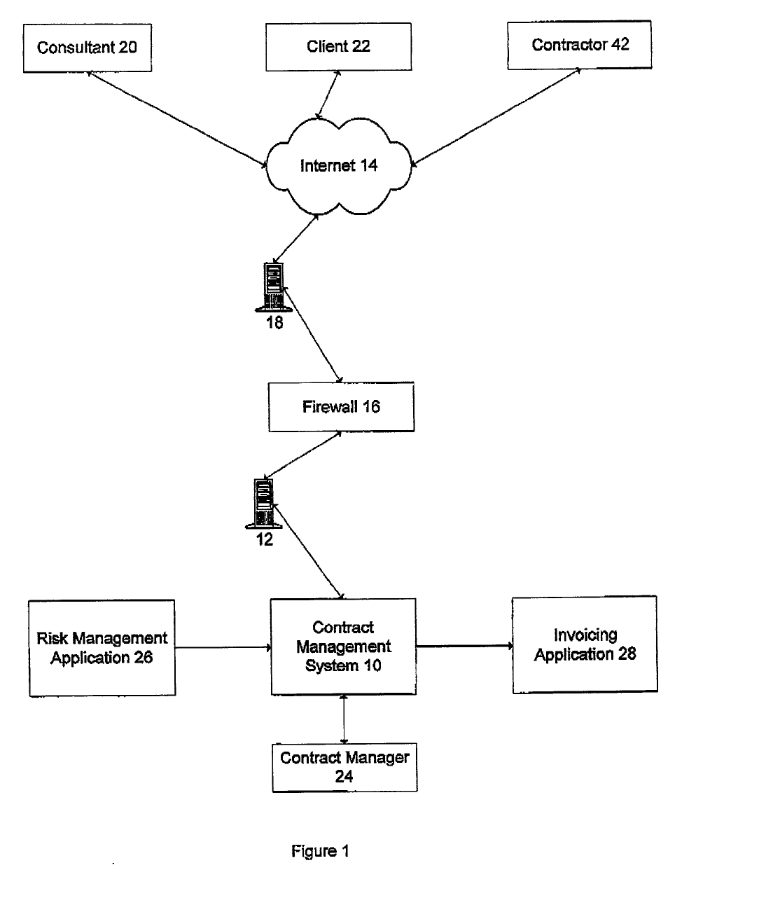

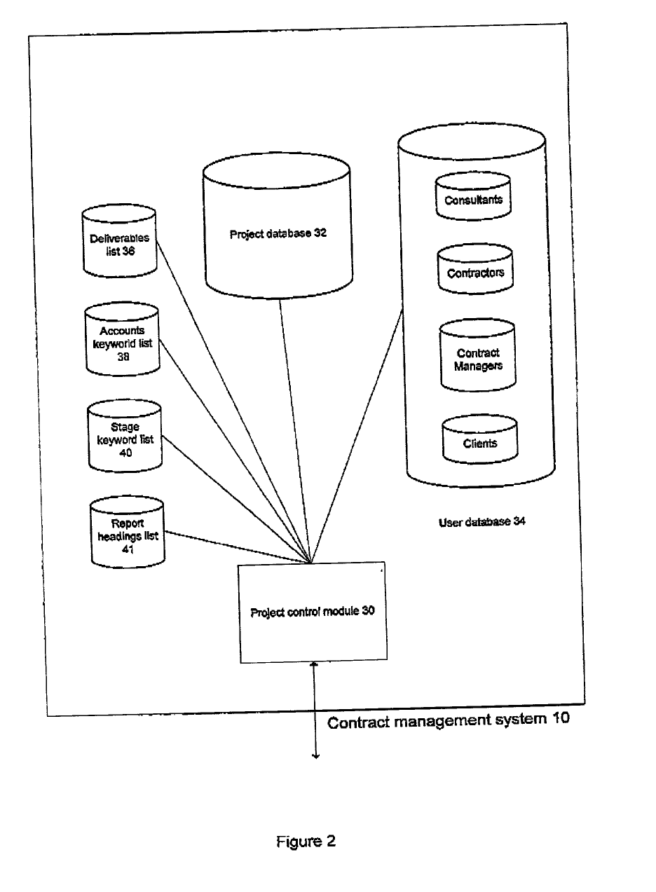

FIG. 1 is a block diagram showing the contract management system in use. The contract management system 10 is implemented as program modules executing on a computer system such as a first server 12. The first server 12 is in communication with a network of computers, which is the Internet 14 in the embodiment. For security purposes, the server 12 is provided behind a firewall 16. A second server 18 is provided between the firewall 16 and the Internet 14 to act as a server for Internet content.

A consultant 20 and a client 22 are able to access the second server 18 and various sections of the contract management system 10 from the second server 18 as described below.

A contract manager 24 has direct access to the contract management system 10.

In the embodiment, the contact management system 10 integrates with several other applications, namely a risk management application 26, and an invoicing application 28. It should be appreciated that in alternative embodiments, either of the external applications 26 or 28 could be implemented as part of the contract management system.

Typically, when a client 22 has a project they wish us to undertake, the client 22 will use a tender process to select contractors who will be responsible for performing the works related to the project, to appoint a consultant to oversee and report on the value of the works performed by the contractors, and to appoint a contract manager 24 to contract manage the project.

The contract management system 10 of the embodiment comprises a project control module 30, a project database 32, a user database 34, a deliverables list 36, an accounts keyword list 38, and a storage keyword list 40. The databases 32 and 34 and the lists 36, 38 and 40 are held within a data store (not shown).

The project control module 30 is operable to provide data from the databases 32 and 34 and the lists 36, 38 and 40 in response to requests and instructions from users, and also to notify users of outstanding events as described in further detail below.

The user database 34 provides information on each user of the system, including a user-type identifier indicating whether each user is a contractor 42, a consultant 20, a contractor manager 24 or a client 22. Users have privileges according to their user-type identifier as described below.

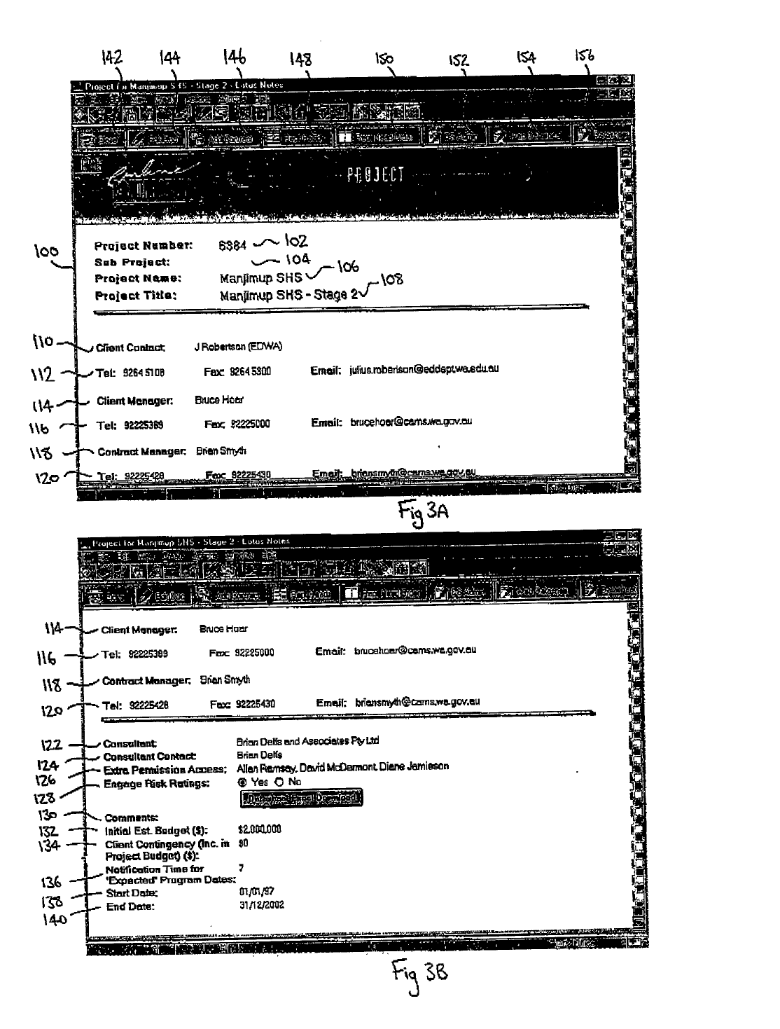

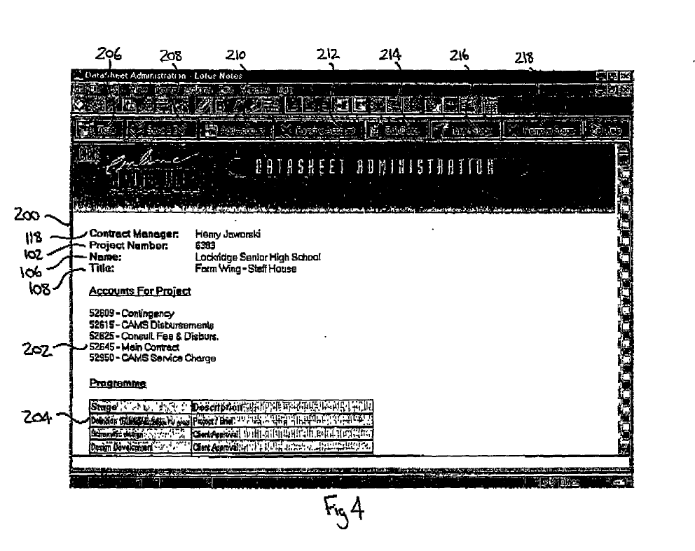

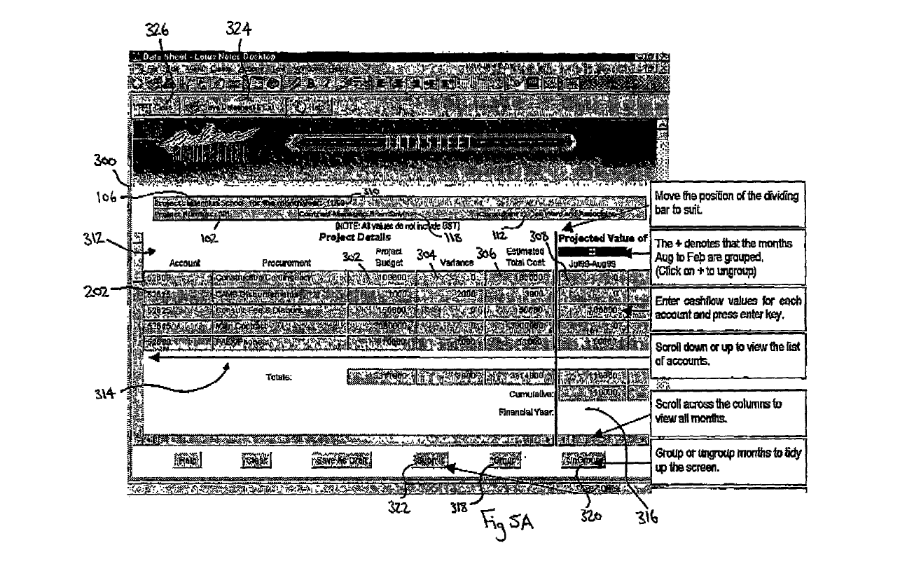

Upon being appointed as the contract manager, a contract manager 24 will establish project data for the new project within the contract management system 10. This is achieved by the contract manager 24 accessing the project control module 30. After providing their name and authorisation information, the project manager 24 is able to access a project sheet 100, as shown in FIGS. 3a and 3B. After supplying the requisite information, the contract manager 24 submits the information to the project control module 30, which then creates a new project in the project database 32.

The project screen 100 provides the contract manager 24 with fields to enter information regarding the project namely:

a project number field 102. The project number field 102 may be automatically populated by the project control module 30 according to an allocation sequence, or alternatively may be specified by the contract manager 24. The project number field 102 is used to identify each project within the contract management system 10

a sub-project field 104, which is used to identify projects which are part of another project.

A project name field 106.

A project tile field 108.

A client contact field 110. This field is selected by the contract manager from a list of clients 22 stored in the user database 34. In the embodiment once the contract manager 24 has entered information into the client contact field 110, three client contact detail fields 112 are automatically populated by the project control module 30 from the user database 34.

A client manager field 114, which is selected by the contract manager 24 from the user database 34. In a similar manner to that described above in relation to the client contact, once the contract manager 24 has entered the client manager field 114, three client manager contact detail fields 116 are automatically populated by the project control module 30 from information in the user database 34.

A contract manager field 118. The contract manager 24 is able to select a contract manager from the user database 34 that will be responsible for this project. Once the contract manager field 118 has been entered, three contract manager contact detail fields 120 are automatically populated by the project control module 30 from information on the selected contract manager from the user database 34.

A consultant field 122. The project manager 24 selects the consultant 20 that has been appointed to oversee the works performed under the project from a list of consultants held in the user database 34.

A consultant contact field 124, which the contract manager is able to select from a list prepared from the user database 34.

An extra permission access field 126. The contract manager 24 is able to select the names of one or more people who are to be provided with limited access to some of the project information stored in the contract management system 10. The names of such people are selected from a list of people stored in the user database 34, and those people may be contractors 42, consultants 20, contract managers 24 or clients 22.

An engage risk ratings field 128, which the contract manager can use to select whether or not the external risk management application 26 will be used in conjunction with this project.

A comments field 130, in which the contract manager 24 can enter a short message.

An initial estimated budget field 132, in which the contract manager 24 enters the initial budget for the project.

A client contingency field 134, in which the contract manager 24 enters the amount of the initial estimated budget entered at field 132 that is for contingency purposes. The client contingency field 134 will have a value of zero in most instances.

A notification time for expected program dates field 136. This field is entered by the contract manager 24 and sets the number dates before an expected program event that the contract manager 24 and the consultant 20 will be notified by the project control module 30, as described in further detail below.

A project start date field 138 and a project end date field 140. These dates specify the maximum duration of the project and are used to construct the datasheet as described in further detail below.

The project screen 100 further includes a close button 142, an edit doc button 144, an add contract button 146, a report headings button 148, a report heading order button 150, a datasheet administration button 152, a web datasheet button 154, and a datasheet button 156.

The close button 142 is used to submit the information entered in the project screen 100 to the project control module 30 to update the information stored in the project database 32 regarding the project.

The edit doc button 144 puts the page in edit mode for data changes by the contract manager 24.

The add contract button 146 is used to add a consultant 20 contract or a contractor 42 contract to the project as described below.

The report headings button 148 causes the project control module 30 to present a list of possible report headings from the report headings list 41 to the contract manager 24. The contract manager 24 is then able to select which report headings he wishes to use for this project. The report heading button 150 allows the contract manager to arrange the order in which the report headings selected using the button 148 will appear in the project report.

The datasheet administration button 152 allows the contract manager 24 to create and administer a datasheet, as described in further detail below.

The web datasheet button 154 provides the contract manager 24 with alternative access to the datasheet through a world-wide web browser.

The datasheet button 156 allows the contract manager 24 to view and administer the datasheet associated with the project, as described in more detail below.

Next, the contract manager 24 can set up the datasheet for the project by clicking on the datasheet administration button 152. This results in the datasheet administration screen 200 being presented to the contract manager 24. The sheet administrations seen 200 includes project identification information in the form of the contract manager field 118, the project number field 102, the project name field 106 and the project title field 108. This information is inserted automatically via the project control module 30 from information provided in the project database 32 regarding the current project.

The datasheet administration sheet 200 also includes at least one account field 202 and at least one project stage field 204.

The account fields 202 list the accounts under which projected expenditure and actual expenditure will be monitored using the contract management system 10.

The project stage fields 204 list the stages forming part of the project, which allows the contract manager 24 to keep track of the progress of the project.

The datasheet administration screen 200 also includes a dose button 206, a save and exit button 208, an add account button 210, a remove account button 212, an edit description button 214, an insert stage button 216 and a remove stage button 218.

The close button 206 is used to exit the data administration screen 200 without saving any changes to the information contained in the datasheet administration screen 200.

The save and exit button 208 is used to save any changes made to the information contained in the datasheet administration screen 200 to the project database 32 by submitting the information to the project control module 30 for storage in the project database 32 and subsequently closes the datasheet administration screen 200.

The add account button 210 presents the accounts keyword list 38 to the contract manager 24, from which the contract manager 24 can select one or more additional accounts to be used in the project. The contract manager 24 selects one or more items from accounts keyword list 38 to be added to the project and upon selecting those accounts, they are included as account fields 202 displayed on the datasheet administration screen 200.

Similarly, the remove account button 212 displays each of the account fields 202 to the contract manager 24. The contract manager 24 is then able to select one or more of the account fields 202, which are then removed from the project and from view on the datasheet administration screen 200.

The edit description button 214 allows the contract manager 24 to change the description associated with each account field 202.

The insert stage button 216 presents the contract manager with the stage keyword list 40 obtained via the project control module 30. The contract manager 24 is then able to select one or more stages to be included in the project. Items selected from the stage keyword list 40 by the contract manager 24 are included as project stage fields 204 and displayed on the datasheet administration screen 200.

The project control module 30 uses information entered on the datasheet administration screen 200 to configure a datasheet screen, which is used to display and track financial information concerning the project, as will be described in further detail below.

Once the contract manager 24 has entered administration details of that datasheet using the datasheet administration screen 200, the project control module 30 creates financial information concerning the project in the project database 32. This financial information includes, for each account field 202 selected by the contract manager 24 for the project, a project budget field 302, a variance field 304 and an estimated total cost field 306. Further, an array of cost values is created for the project, with the columns representing months over the duration of project identified from the project start date field 138 and the project end date field 140, and the number of rows in the array being determined by the number of account fields 202, Each element 308 in the array represents a projected value to be incurred for a particular account field 202 for a particular month of the project.

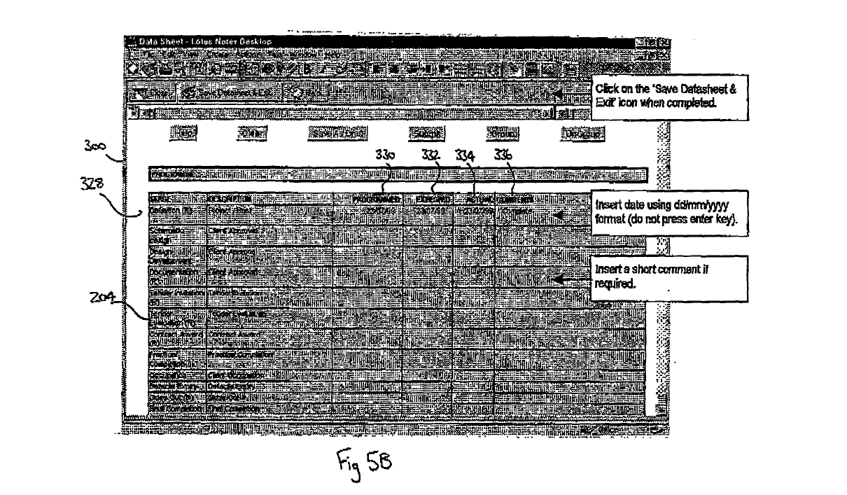

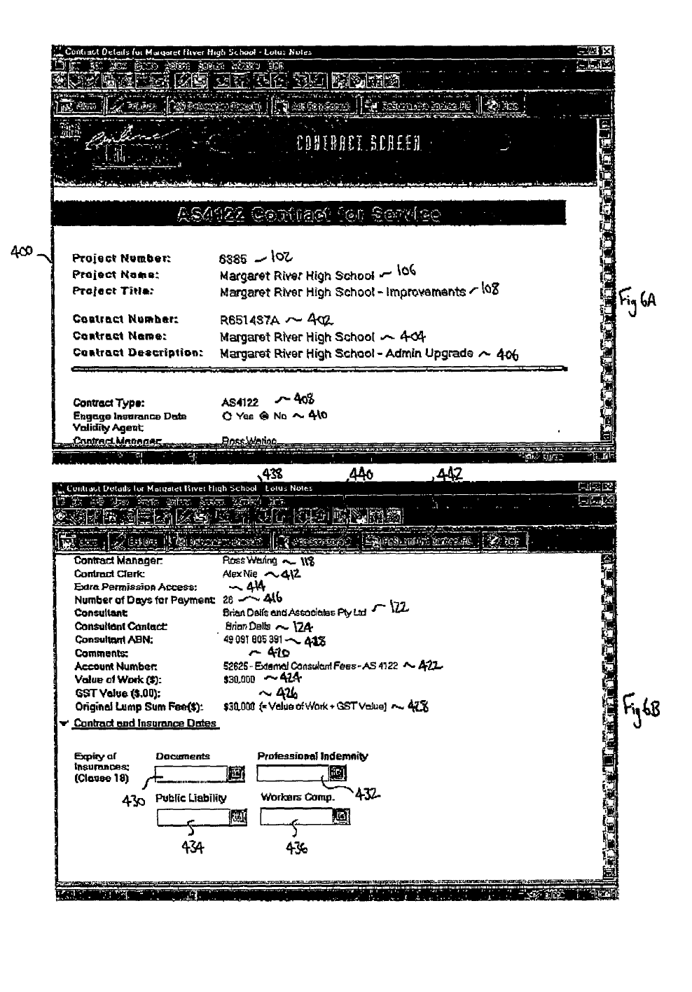

The contract manager 24 is able to access a datasheet screen 300, shown in FIGS. 5a and 5b, by selecting the datasheet button 156. The datasheet screen 300 includes project identification information, such as the project number field 102, the project name field 106, the consultant field 122 and the contract manager field 118. The current month and year is also displayed at 310.

The datasheet comprises two sections. The first section is a financial information section, shown in FIG. 5a at 312. The financial information section 312 includes an overview pane 314 that lists each of the account fields 202 for the project and their corresponding description. Next to each account field 202, the project budget field 302, the variance field 304 and the estimated total cost field 306 is displayed for each account field 202 to provide an overview of the total cost of the project. Information for the project budget field 302 can be entered by the contract manager 24 based on information from the successful tender, or alternatively may be provided by the consultant 20. The value of the variance fields 304 are initially zero, and are adjusted when the contract manager 24 accepts a fee variation submitted by the consultant 20, as described below.

The financial information section 312 also includes a cash flow pane 316 that displays the elements 308 in the array of projected expenditure for the duration of the project. This information is typically entered by the consultant 20.

To make the cash flow pane 316 more manageable, a group button 318 and an ungroup button 320 are provided which allows a user to group adjacent months together so they are displayed as a single column. Where two or more months are group together, the values appearing in the cash flow pane 316 represent the cumulative sum of the elements 308 for each account during those months. A submit button is also provided which causes the information in the financial section 312 to be submitted to the project control module 30, which in turn updates the information stored in the project database 32 concerning the project.

The datasheet screen 300 also includes a save and exit button 324 which submits all of the information on the datasheet to the project control module 30 to update the project database 32, and a close button 326 which closes the datasheet screen 300 with out submitting any changed information to the project control module 30.

The datasheet screen 300 also includes a program section 328. The program section 328 lists each of the project stage fields 204 and their corresponding description. A programmed date field 330, an expected date field 332, an actual date field 334 and a comment field 336 are provided adjacent to each program stage field 204.

The programmed date field 330 indicates the date on which the corresponding program stage 204 was programmed for an expected completion date. The expected completion date field 332 indicates when each program stage 204 is expected to be completed, and the actual completion date field 334 lists the actual completion date for that program stage field 204. The comments field 336 is provided to allow the consultant 20 to enter a short comment regarding the project stage 204 if necessary. The information contained in the program section 328 is stored in the project database 32 when the information on the datasheet screen 300 is submitted to the project control module 30.

The datasheet screen 300 provides the contract manager 24 with a simple but powerful interface to view the total financial progress of the project, and to also view the project stage completion according to the program project stages.

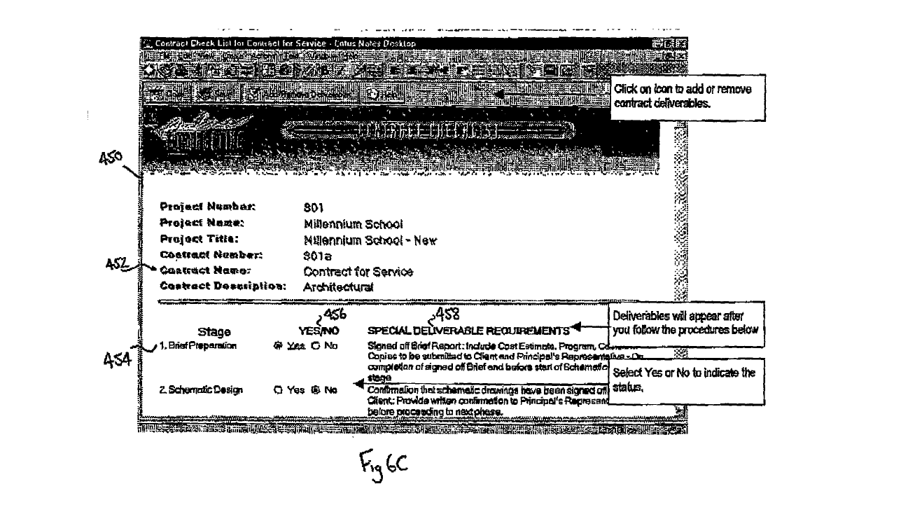

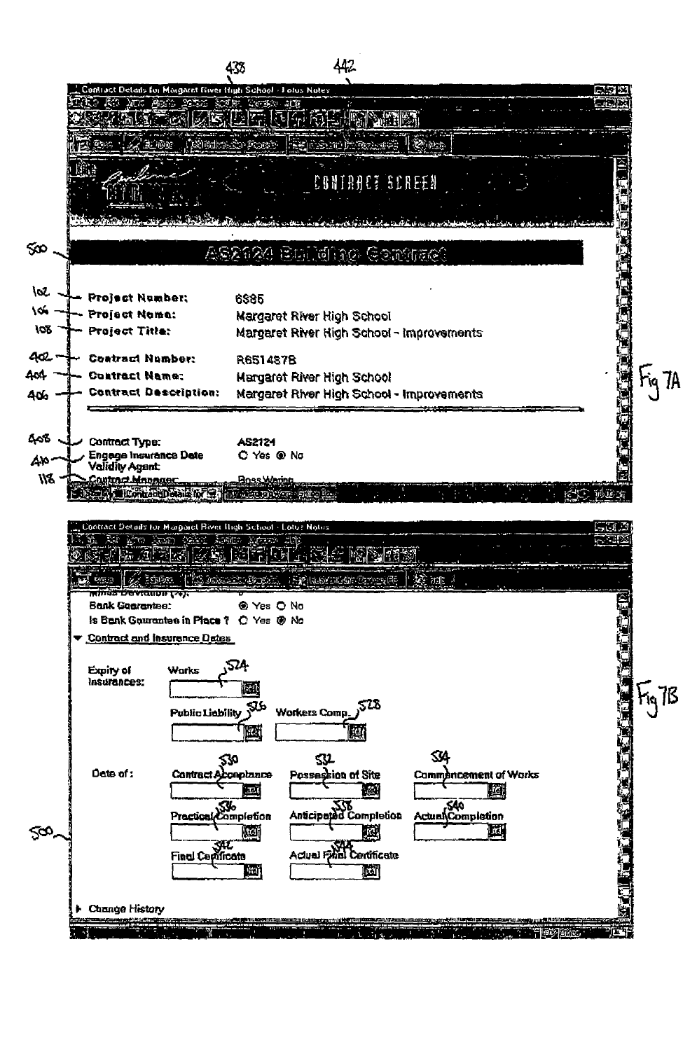

Details concerning the contract under which the consultant 20 is engaged for the project can be configured by the contract manager 24 by selecting the add contract button 146. The contract manager 24 is presented with a contract screen 400, which is shown in FIGS. 6A and 6B.

The contract screen 400 includes information identifying the project, namely the project number field 102, the project name field 106, and the project title field 108. These fields are populated from the project database 32 by the project control module 30.

The contract screen 400 also includes fields identifying the contract, in the form of:

A contract number field 402 that identifies the contract engaging the consultant 20 for the project;

A contract name field 404; and

A contract description field 406.

The fields 402, 404 and 406 are populated from the project database 32 if this information was previously entered in relation to this project Otherwise, the contract manager 24 inserts the relevant information.

The contract screen 400 further includes fields configuring the details of the contract under which the consultant 20 is engaged for the project. These are:

A contract type field 408 that stores the nature of the contract under which the consultant 20 is engaged. In the embodiment, this field has a value of AS4122, identifying Australian Standard 4122 available from Standards Australia, that establishes requirements for contracts engaging consultants for capital works projects. In other embodiments, other contract types may be provided for;

An engage insurance date validity agent field 410. The contract manager 24 enters whether the contract management system 10 will monitor the expiry date of various insurances the consultant 20 is required to maintain;

The contract manager field 118 is also displayed from information retrieved from the project database 32;

A contract clerk field 412 that identifies a support staff person to whom approved claims are automatically sent by the project control module 30;

An extra permission access field 414, with which the contract manager 24 is able to select other users from the user database 34 that will be able to view information regarding the contract;

A number of days for payment field 416, in which the contract manager 24 enters the number of days from the submission of a fee claim within which payment must be made to the consultant 20. In the embodiment, a default value of 28 is displayed which can be changed by the contract manager 24;

The consultant field 122 is displayed from information retrieved from the project database 32;

The consultant contact field 124 is displayed from information retrieved from the project database 32;

A consultant business number field 418 is displayed from information retrieved from the user database 34 concerning the consultant 24;

A comment field 420 in which the contract manager 24 can insert a text comment regarding the contract;

An account number field 422, in which the contract manager 24 specifies to which account field 202 the consultant's fees will be attributed;

A value of work field 424, in which the contract manager 24 enters the value of the fee that the consultant 20 will charge for its services under the contract. This value is determined by the outcome of the tendering process conducted by the client 22 in most instances. The value of work field 424 reflects the current value of the fee the consultant 20 will charge for its services under the contract, including any variations;

A GST value field 426, in which the contract manager 24 enters the taxation amount payable by the client 22 on the amount specified in the value of work field 424;

An original lump sum field 428, in which the contract manager 24 enters the value of the fee that the contractor 24 will charge for its services under the contract prior to any variations, but including any taxation amount indicated in the GST value field 426. The value of the original lump sum field 428 does not change if variations are submitted by the consultant 22, thus allowing the contract manager 24 to compare the original figure with the current value of the work performed by the consultant 20 under the contract.

The contract screen 400 also includes the following date fields:

A document date field 430 corresponding the expiry date of the consultant's contract under the project

A professional indemnity insurance expiry date 432 in which the current expiry date of the consultants professional indemnity insurance is entered:

A public liability expiry date field 434 in which the expiry date of the consultants public liability insurance is entered; and

A worker's compensation expiry date field 436 in which the consultant's worker's compensation insurance will expire.

If the contract manager 24 has selected that the insurance date validity agent should be engaged at field 410, e-mail reminder will be sent to both the contract manager 24 and the consultant 20, 30 days before the expiry of any of the date fields 430-436. This provides a timely reminder to the consultant to renew the appropriate insurance, and also notifies the contract manager that one of the consultants insurances is fulling due.

Further, if the contract manager 24 has selected the insurance data validity agent as being enabled at field 410, the project control module 30 will not accept payment certificates from the consultant 20 until the insurance is in place.

The contract screen 400 further includes a deliverables checklist button 438. When the contract manager selects this button, the deliverables list 36 is displayed from which the contract manager 24 can select deliverables to be provided under the contract A list of deliverables selected by the contract manager 24 is maintained in the project database 32 for the contract, This list is accessible by the consultant 20, as described below, so the consultant can keep track of which deliverables are outstanding and which have been provided. This is shown in FIG. 6(c) in a contract checklist screen 450 information concerning the project and the contract are displayed at 452 and are automatically inserted from information available from the project database 32. The contract check screen 450 further includes a list of deliverables expected under the contract at 454, with an indication at 456 whether each deliverable has been provided to date, and a requirement description for each deliverable at 458. The list of deliverables 454, the status of the deliverables at 455 and the requirement description at 458 are all stored in the project database 32 for the project. This information can be viewed by the consultant 20 but is maintained by the contract manager 24.

The add contconst button 440 gives the contract manager 24 access to the user database to add or edit details of a contractor 42 or consultant 20. This information is access by the contract manager 24 from a drop down menu when populating the project screen 100 or contract screen 500 or 600.

The resubmit this contract PC button 442 allows the contract manager 24 to progress a payment certificate submitted by the consultant 20 and which was initially rejected. A payment certificate is automatically rejected if the contract management system 10 detects that the contractor's insurance has expired or the consultant 20 has stated he has not received the Statutory Declarations. The project control module 30 automatically sends an e-mail to the contract manager 24 pointing this out and stops the automatic processing of the Payment Certificate. When the contract manager 24 is satisfied the outstanding items have been put in place, he then clicks on the Resubmit this Contract PC button 442 to electronically send it on its way to clerical support for processing. This is described in more detail below.

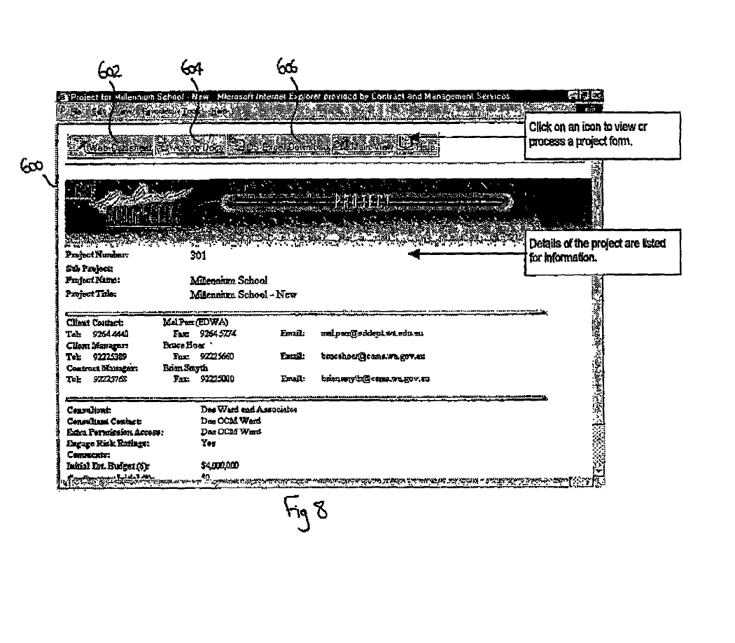

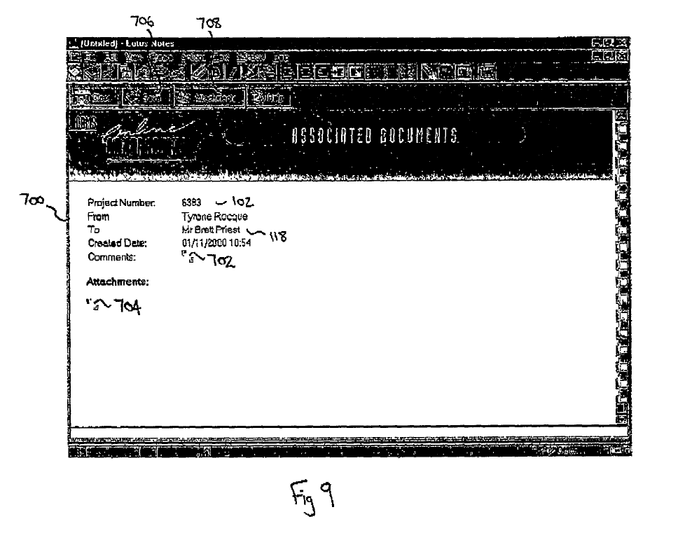

Similarly, the contract manager 24 is able to configure the contract under which a contractor 42 is engaged for the project by selecting the add contract button 146. The contract manager 24 is presented with a contract screen 500, which is shown in FIGS. 7(a) and 7(b). The contract screen 500 is of the same general form as the contract screen 400 shown in FIG. 6(a) and 6(b), and like reference numerals are used to denote like parts.

The difference between the contract screen 500 and the contract screen 400 is that in the contract screen 500 the contract manager 24 has selected a different contract type at the contract type field 408. In the contract screen 500, the contract manager has selected a contract type of AS2124 in the contract type field 408, which signifies a contractor to the project.

As soon as the contract type field 408 is selected by the contract manager, additional fields are made available depending upon the contract type. For a contractor engaged under an AS2124 contract, which is available from Standards Australia, these further fields are:

An initial contingency field 502, in which the contract manager 24 can enter a contingency value relating to the contract;

An agreed contingency field 504

A contract upper limit field 506 In which the contract manager 24 can enter the maximum tolerable amount of this contract, which is typically composed of the tendered price plus a tolerance variation, which, if exceeded, will result in a notification being sent to the contract manager 24 by the project control module 30 as described in more detail;

A consultant approval variation limit field 508, in which the contract manager 24 can specify a value for variations submitted by the consultant 20 which will automatically be approved by the project control module 30 without requiring acceptance from the contract manager 24;

An initial practical completion time field 510, in which the contract manager 24 inserts the expected construction period;

A defects liability period field 512 in which the contract manager 24 enters the period of defect liability for the contractor;

A liquidated damages field 514 in which the contract manager 24 can insert an amount for liquidated damages if these are provided for in the contract;

A plus deviation field 516 and a minus deviation field 518, in which values are automatically inserted from the risk assessment application which trigger warning messages to the contract manager 24 if the actual expenditure for a given month deviates from the estimated expenditure for that month by more than the values in the plus or minus deviation fields 516 and 518. The contract manager 24 can edit the value in these fields to other values if desired;

A bank guarantee field 520, in which the contract manager 24 indicates whether the performance of the contractor is guaranteed by a bank or other financial institution;

A bank guarantee in place field 522, in which the contract manager 24 indicates whether the bank guarantee has been established.

If the contract manager indicates in the bank guarantee field 520 that a bank guarantee is not available for this contract, then additional fields appear. These are a security field in which the contract manager indicates a value of security that has been provided by the contractor, a security type in which the contract manager 24 indicates the manner of security provided for the contract; a defects liability sum, in which the contract manager indicates the maximum value of defects liability for which the contractor will be liable; and a defect period in which the contract manager 24 indicates the period for which the contractor is liable for defects.

In addition, the contract screen 500 also includes insurance expiry dates in a similar manner to the contract screen 400. In the case of a AS2124 contract, these dates are;

A works insurance expiry date 524;

A public liability insurance expiry date 526;

A workers compensation insurance expiry date 528.

In a similar manner to that described for the contract screen 400, if the contract manager 24 indicates in the engaged insurance date validity agent field 410 that the validity agent is to be engaged, then the contractor 42 and the contract manager 24 will receive a e-mail notification 30 days before the expiry of any of the insurances indicated by the expiry fields 524-528.

In addition, the contract screen 500 includes further date fields, which are used to track the progress of the construct performed by the contractor. These date fields comprise:

A contract acceptance date 530;

A possession of site date 532;

A commencement of work state 534;

A practical completion date 536;

A anticipated completion date 538;

An actual completion date 540.

A final certificate date 542; and

An actual final date 544.

Each of the above date fields 530-544 are entered and managed by the contract manager 24. The information in the contract screen 500 is stored in the project database 32 for this project. The contractor 42 engaged under the contract shown in the contract screen 500 also has access to the contract screen 500 to view the information thereon and to keep track of the progress of their contract relative to the completion dates and other milestones indicated in the date fields 530-544.

In a similar manner to that described above in relation to the contract screen 400, the contract screen 500 includes a deliverables checklist button 438 and a resubmit this PC button 442, which operates in the same manner as described above for the contract screen 400.

In use, the contract management system 10 is accessed by consultants, contract managers, clerical support and clients in progressing and managing the project and contracts between the parties related to that project.

As previously mentioned, the contract manager 24 and clerical support have direct access to the contract management system 10. Consultants 20 and clients 22 access the contract management system 10 via the Internet 14. In order to obtain access to the contract management system 10, these consultants and clients must first provide a user name and password in order to validate their identity. Information from the contract management system 10 is provided to the consultants and clients in the form of hypertext marked-up language (HTML) documents or other suitable equivalents. Similarly, known tools for submitting information over the Internet 14 are used to receive information from the consultant to the project, such as Javascript from Sun Microsystems and forms.

An additional facility is provided for consultants 20 to view and print information from the datasheet in a Microsoft spreadsheet. This is achieved by the use of a macro to format a Microsoft Excel spreadsheet into a similar format to the datasheet screen 300 based on data exported from the contract management system 10. A consultant 20 is able to access the macro by clicking on the datasheet excel download button in the project screen 100. After installing the macro, the consultant is able to use the macro to import data exported from the contract management system 10. In the current embodiment, data imported into a Microsoft excel spreadsheet is a copy of the data, and any changes made to that data cannot be saved into the contract management system 10. To change and update information regarding a contract, a consultant 20 is required to use the Internet interface as described below.

After providing their user name and password, a consultant 20 is presented with a list of projects for which they are engaged. This information is obtained from the project control module 30 which assimilates the information contained in the project database 32 and presents it in a suitable HTML format for transmission to the consultant 20 via the Internet 14.

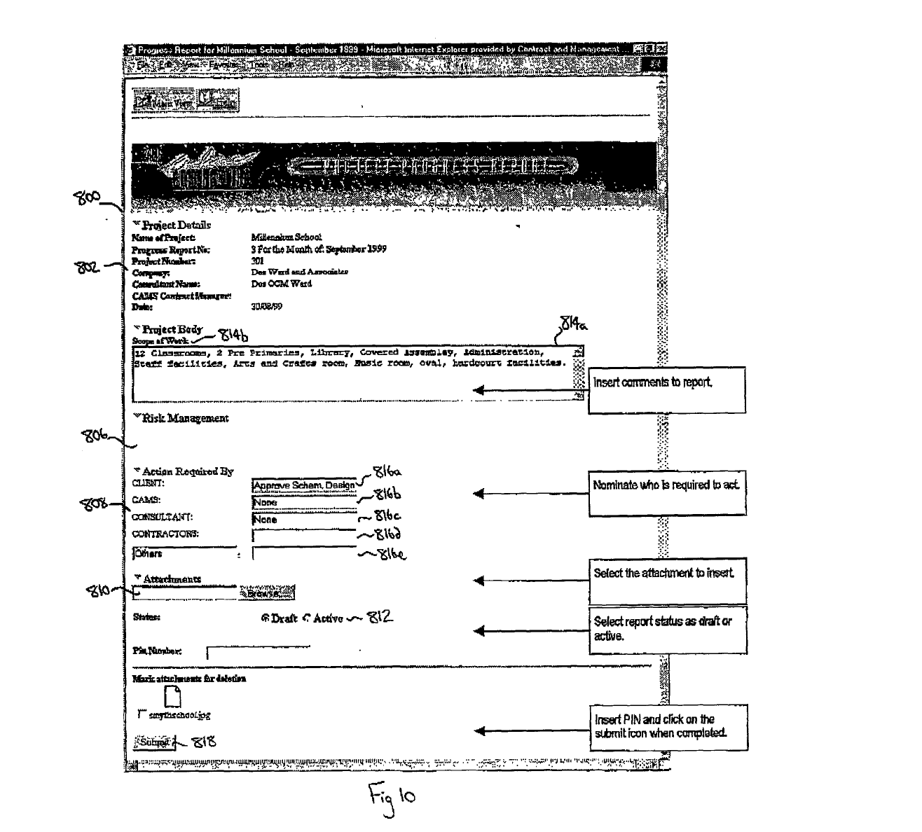

The consultant 20 can select any project for which they are currently the contracted consultants. Doing so will present the consultant 20 with a consultant project screen 600 shown in FIG. 8. The consultant project screen is substantially identical to the project screen 100 shown in FIGS. 3a and 3b, however the consultant 20 is not able to modify any of the information on the consultant project screen 600.

Further, the consultant project screen 600 does not include any of the buttons 142-156 present in the project screen 100 used by the contract manager 24. Instead, the consultant project screen 600 includes a web datasheet link 602, an associated documents link 604, a datasheet excel download link 606.

Selecting the web datasheet link 602 presents the consultant 20 with a consultant datasheet screen, which is of the same form as the datasheet screen 300 shown In FIGS. 5a and 5b. From the consultant datasheet screen, the consultant is able to enter financial data in the project budget fields 302 for the project. The consultant 20 is also able to enter cash flow values in the entries 308 contained in the cash flow section 316 with the datasheet, Thus, the consultant 20 is able to maintain the financial information relating to the expected costs of the project remotely from the contract management system 10. The consultant 20 is able to submit the amended information to the contract management system 10 via the Internet whereupon the information is updated in the project database 32 by the project control module 30.

The consultant is also able to maintain the program for the project by entering values in the programmed date field 330, the expected data field 332, the actual date field 334 and the comment field 336. When the consultant 20 submits updated information from the consultant datasheet to the contract management system 10, the project control module 30 is arranged to store the updated data in the project database 32, and to send an e-mail notification to the contract manager 24 identified in the contract manager field 118 that the datasheet has been updated. The contract manager 24 is then able to view the datasheet via the datasheet screen 300 to assess the nature of the change.

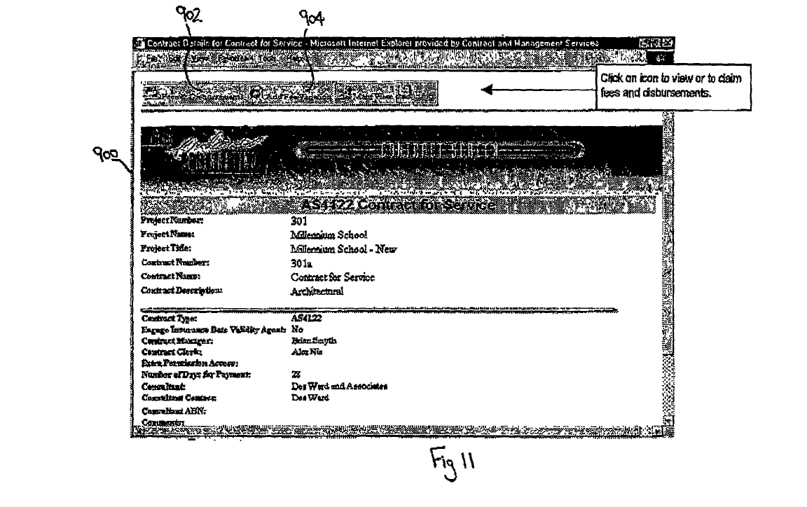

By selecting the associated documents link 604 from the consultants project screen 600, the consultant is presented with an associated document screen 700 shown in FIG. 9. The associated documents screen includes identification information automatically inserted by the project control module from the project database 32 and the user database 34. By default, the addressee of the associated documents is the contract manager 34 nominated in the contract manager field 118. The associated document screen 700 includes a comments field 702 in which the consultant 20 is able to enter a comment regarding the nature of the associated document, and an attachments field 704 in which attached documents are represented.

Further, a save button 706 is provided which submits the attached documents represented at field 704 and the comments from 702 to the contract manager 24.

An attachment button 708 is provided to allow documents to be attached to the screen 700 and represented at attachment field 704. In this manner, the consultant 20 is able to electronically provide documents associated with the project to the contract manager 24. This facility has a wide range of uses, such as for submitting electronic photographs of the construction site for the contract manager's reference, or submitting deliverable documents such as CAD documents of the project design.

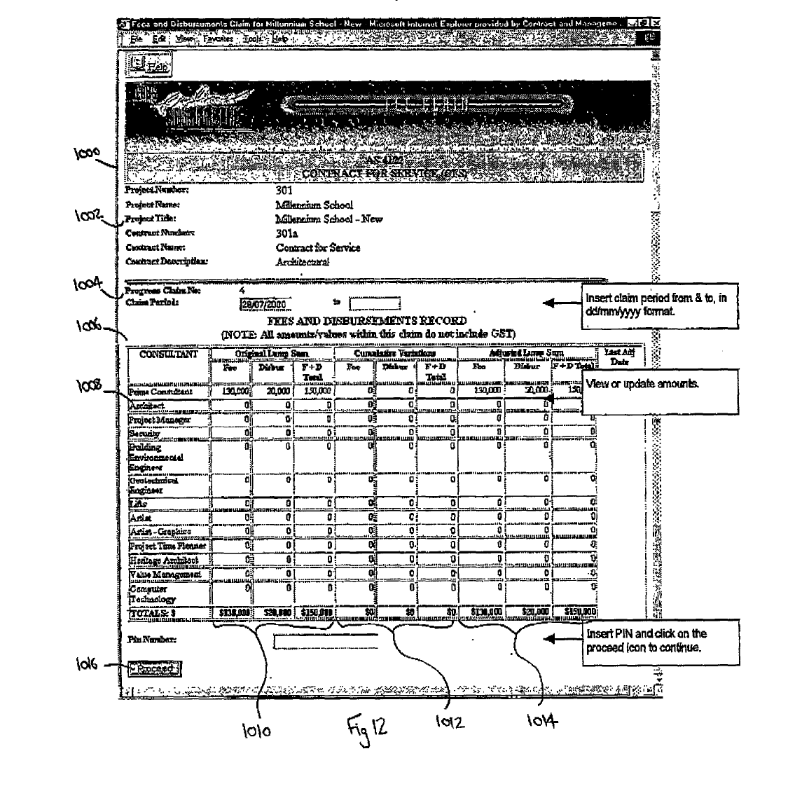

The consultant 20 is able to click on a project progress report link (not shown) on the consultant project screen 600 to access a project progress report screen 800, shown in FIG. 10. The project progress report screen 800 includes a project details section 802, a project body section 804, a risk management section 806, an action required section 808, an attachments section 810 and a status section 812.

Information for the project details section 802 is automatically inserted by the project control module 30 based on information retrieved from the project database 32.

The first time the consultant 20 accesses the project progress report screen 800 for a particular project, information will only be present In the project details section 802, with the remainder of the project progress report screen 800 being arranged to receive information from the consultant 20 regarding the project. In the embodiment, the consultant 20 is required to submit a progress report every month. Advantageously, when the consultant 20 accesses the project progress report screen 800 for the second and subsequent month's progress report, the project control module 30 is arranged to insert the information submitted as the previous month's progress report into the project progress report screen, so that the consultant 20 simply needs to add to the existing information to reflect the current month's activity,

The project body section 804 includes at least one text box 814(a) and associated heading 814(b). The number of text boxes 814(a) displayed on the project progress report screen 800 is determined by the number of report headings selected by the contract manager 24 using the button 148 in the project screen 100 described above. A separate text box 814(a) is provided for each such report heading selected by the contract manager 24. Furthers the heading 814(b) of each text box 814(a) corresponds with the report heading descriptions selected by the contract manager 24. Still further, the text boxes 814(a) and heading 814(b) appear in the order selected by the contract manager 24 using the report heading order button 150. The consultant 20 is able to enter a text description under each of the headings 814(b) by simply typing a comment in the corresponding text box 814(a). As previously mentioned, the text boxes 814(a) will contain the text of the previous progress report is one has been submitted.

The risk management section 806 may also include text boxes and associated headings. The number of text boxes displayed in the risk management section 806 is determined by the number of report headings selected by the contract manager 24 from the risk management application. In alternative embodiments, a list of risk management headings may be provided in the database for the contract manager to select from. A separate text box is provided for each such report heading selected by the contract manager 24. The consultant 20 reports on these headings by entering information in the text boxes in the same manner as for the text boxes 814(a).

In the action required section 808, the consultant 20 is able to nominate whether further action is required by each of the client 22, contract manager 24, the consultant 20, the contractor 42 or other parties by entering information in text boxes 816(a)-815(e), respectively.

The consultant 20 is able to attach documents to the progress report at the attachment section 810.

The status section 812 allows the consultant 20 to indicate whether the progress report is a draft or is an active report, If the consultant 20 indicates that the progress report is a draft, information submitted to the project control module 30 is stored in the project database 32 and the contract manager 24 is notified for information purposes only. When the consultant 20 again accesses the project progress report 800, the current information previously stored in draft form is presented in the project progress report screen 800 for the consultant 20 to continue work on.

If the consultant 20 indicates that the stats of progress report is active, then when the progress report is submitted to the project control module using the submit button 818, the progress report is stored by the project control module 30 in the project database 32 as the active progress report for the current month. Further, the project control module 30 sends an e-mail notification to the contact manager 24 that an active progress report has been submitted by the consultant 20.

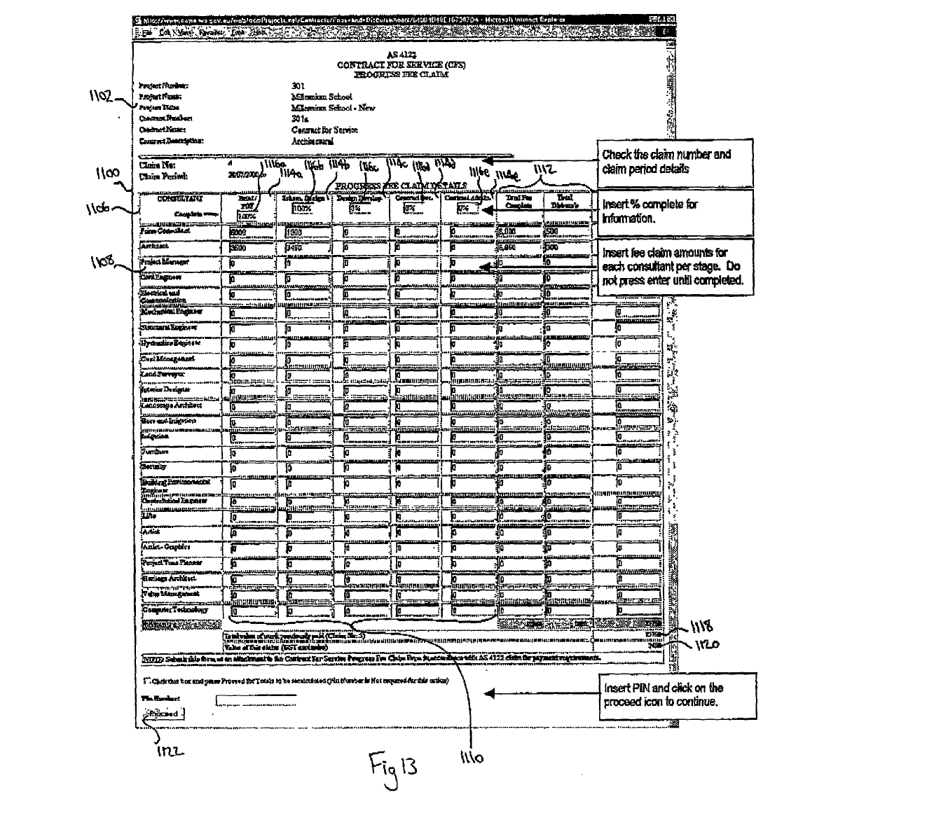

The consultant 20 is also able to access a consultant contract screen 900 shown in FIG. 11. The consultant contract screen 900 displays the same information as the contract screen 400 as described above and shown in FIGS. 6(a) and 6(b), however the consultant 20 is not able to modify the information. In addition, the consultant contract screen 900 includes a fees and disbursements link 902 and add fee variation link 904.

By selecting the fees and disbursements link 902, the consultant 20 is presented with a fee claim screen 1000, shown in FIG. 12. The fee claim screen 1000 includes a project information section 1002, a progress claim section 1004 and a fees and disbursements record 1006. Information for the project information section 1002 is obtained from the project database 32 and is automatically inserted in to the fee claimed screen 1000 by the project control module 30.

The progress claim section 1004 includes the progress claim number for the contract and the claim period.

The fees and disbursements record 1006 includes a list of each consultant engaged under the project at 1008, and lists the fees and disbursements for each consultant originally tendered at 1010, the accumulative total of any variations to the original fees and disbursements at 1012, and the adjusted total of fees and disbursements at 1014. Information for the figures displayed at 1010, 1012 and 1014 are retrieved by the project control module 30 from the project database 32 based on information entered in datasheet screen. After entering the relevant claim period at the progress claim section 1004 and reviewing the fees and disbursements record 1006, the consultant 20 can click a proceed button 1016 to continue with submitting a fee claim under the project.

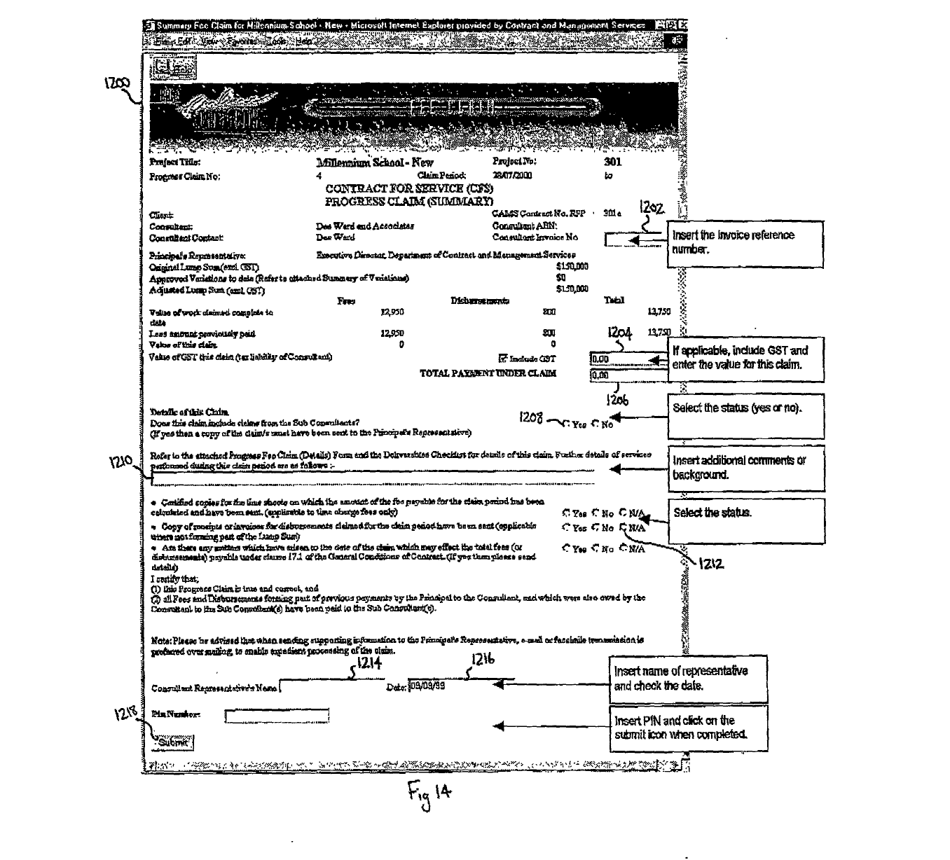

Activitating the receive button 1016 displays a progress fee claim screen 11, which is shown in FIG. 13. The progress fee claim screen 1100 includes a project identification section 1102, a claim identification section 1104 and a fee claim detail section 1106.

The project identification information section 102 includes information retrieved automatically by the project control module 30 from the project database 32 for the project. The claim identification section 1104 includes the claim number and claim period information obtained from fee claims screen 1100.

The fee detail section 1006 includes a list of each consultant to the project at 1008, claimed fees for each consultant at 1110 and fee and disbursement totals at 1112. In the embodiment, the fee claims are broken down into five stages represented by the columns 1114(a)-1114(e). The fee claim detail section 106 also includes progress indicators 1116(a)-1116(e), each of which is provided adjacent one of the corresponding stages 1114(a)-1114(e).

The consultant 20 is then able to insert amounts for each sub-consultant to the project corresponding to their services to date. The consultant divides the value between the five stages 1114(a)-1114(e) of the project. The consultant is also able to provide an indication in the progress indicators 1116(a)-1116(e) of the percentage of completion of each of the stages 1114(a)-1114(e).

For the second and subsequent fee claims, previously claimed values of fees for service for each of the consultants and sub-consultants is inserted by the project control module 30 from the project database 32. The project control module 30 also total the value of the previous fee claim and displays it at 1118. As the consultant updates the value of fees and disbursements claimed by each of the contractors and sub-contractors listed 1108, a value of the current progress fee claim is displayed at 1120.

To proceed to submit the fee claim, the consultants 20 selects the proceed button 1122.

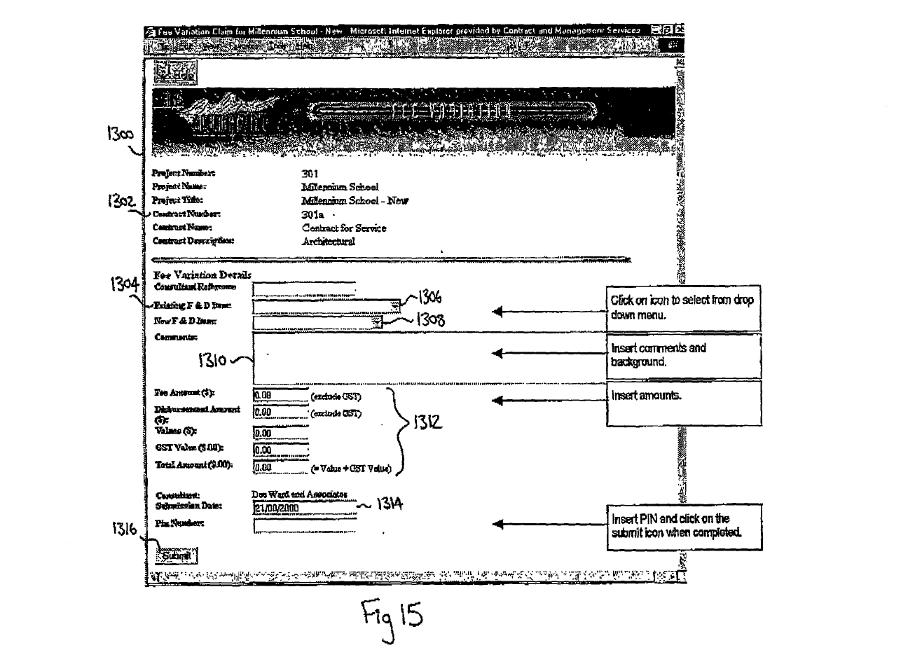

After selecting the proceed button 1122, the consultant 20 is presented with a progress claim summary screen 1200 which is shown in FIG. 14. Information on the progress claim summary screen 1200 is inserted by the project control module 30 from information in the project database 32. The consultant 20 is then able to enter their invoice number at 1202, the value of any tax liability under this claim at 1204 and the total payment under the claim at 1206.

At 1208, the consultant 20 indicates whether the progress fee claim includes claims from sub-consultants, and at 1210, the consultant 20 is then able to enter any additional comments concerning this fee claim.

At 1212, the consultant 20 indicates whether copies of receipts and time sheets for the fees and disbursements payable under the contract have been or will be provided, and whether any matters have arisen which may effect the fees payable under contract.

Finally, the consultant 20 indicates their representatives name at 1214 and the date at 1216 and can then submit the progress fee claim by selecting the submit button 1218. Upon selecting the submit button at 1218, the information from the progress fee screen 1100 and the fee claim summary screen 1200 are submitted to the contract management system 10 where they are stored in the project database 32. The project control module 30 then notifies the contract manager 24 by e-mail that a fee claim has been submitted for the project.

Upon receiving the notification, the contract manager 24 is able to view the information contained in the fee claim screen 1200 and the progress fee claim screen 1100, following which the contract manager 24 can elect to approve, reject or amend the fee claim. In addition, if the insurance validity agent is enabled for this contract, the fee claim will be automatically rejected by the project control module 30 if any of the insurance dates for the consultant 20 indicated at the expiry date field 430-436 have passed. This rejection appears in the form of a splash screen once the consultant clicks on the fee claim icon.

If the contract manager 24 approves the fee claim, the project control module 30 exports payment information to the invoicing application 28 which forwards payment to the consultant 20. If the contract manager 24 rejects the fee claim submitted by the consultant 20, the contract manager 24 is prompted to indicate reasons why the fee claim has been rejected, which are then submitted to the project control module 30 which stores those reasons in the project database 32 and forwards them to the consultant 20 for rectification.

If the contract manager 24 decides to amend the details of the fee claim, in addition to making such amendments, the project manager 24 is required to provide an explanation of why the amendments have been made. Upon submitting the amendments to the project control module 30, the amended fee claim and reasons are stored by the project control module 30 in the project database 32 and a copy of the amended fee claim and reasons for the amendment are forwarded to the consultant 20. After making such an amendment, the consultant 20 can then again choose whether to approve or reject the fee claim.

Advantageously, the contract manager 24 is able to view whether all of the deliverables to be provided under the contract have been provided by reviewing the contract checklist screen 450.

In the event that a variation to one of the estimated fees for the project is required, the consultant 20 is able to submit a fee variation by selecting the add fee variation link 904 from the contract screen 900.

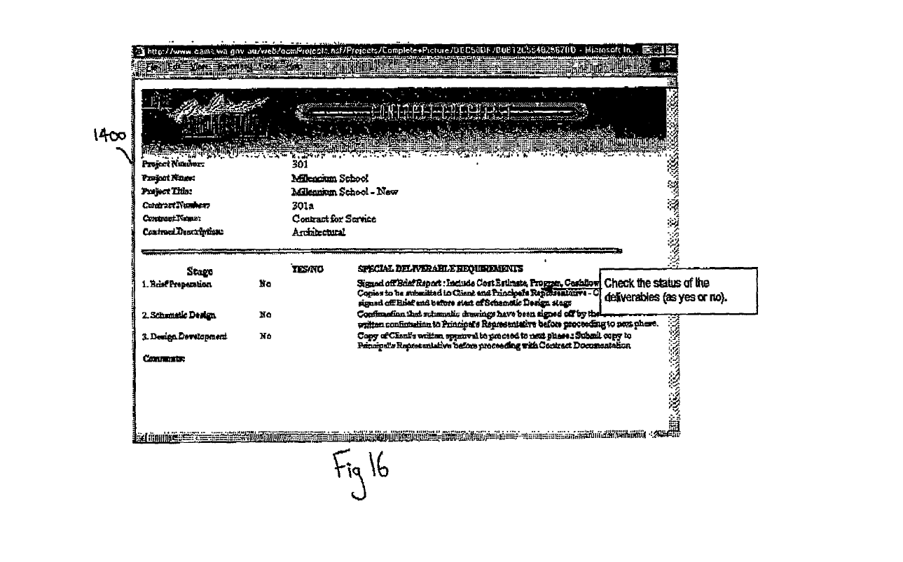

After selecting the add fee variation link 902, the consultant 20 is presented with a fee variation screen 1300, which is shown in FIG. 15.

The fee variation screen 1300 includes a project information section 1302 and a fee variation section 1304. Information in the project information section 1302 is automatically inserted by the project control module 30 from information in the project database 32.

The consultant 20 enters information concerning the fee variation and its reason in the fee variation section 1304. This information includes the fee and disbursement item that is subject to the variation at 1306, the new fee and disbursement item that will result in the variation, if appropriate, at 1308, comments on the reason for the variation at 1310, the new fee and disbursement amounts, including any tax component thereof at 1312 and the date of submission of the fee variation at 1314.

Once the consultant 20 has entered the information concerning the fee variation in the fee variation section 1304, the consultant can submit the fee variation by selecting the submit button 1316. Information on the fee variation section 1304 is received by the project control module 30, when then forwards the fee variation to the contract manager 24 for approval. Once the contract manager 24 approves the variation, the project control module 30 stores the updated fees and disbursements data in the project database 32.

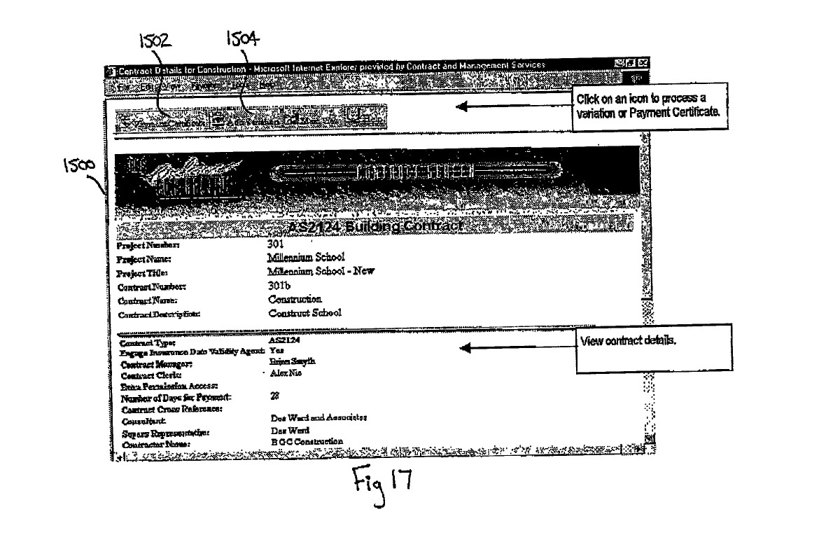

Further, the consultant 20 is able to access the checklist of deliverable items under the contract for service for the project by accessing a consultant contract checklist 1400, which is shown in FIG. 16. The information shown in the consultant contract checklist screen 1400 is the same as that shown in the contract checklist 450 shown in FIG. 6(c), however the consultant 20 cannot modify any of the information. The consultant contract checklist screen 1400 allows the consultant 20 to keep appraised of any outstanding deliverables required under the contract of service and to notify the contract manager if deliverables that have been supplied are stilled indicated as being outstanding.

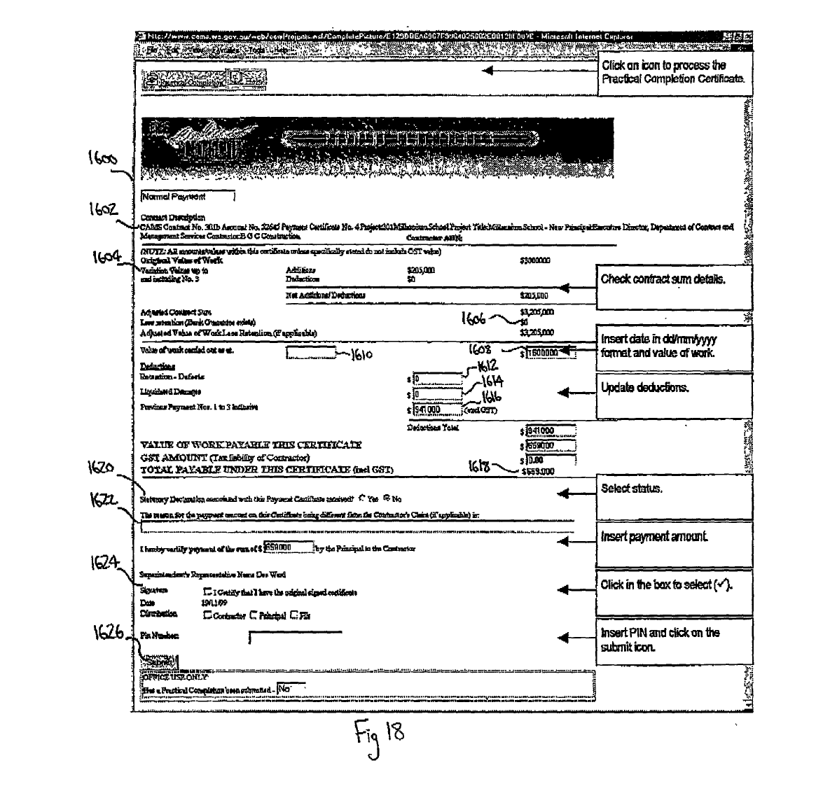

The consultant 20 is also able to access a further contract screen 1600 for each contractor that the consultant is reasonable. An example of the further contract screen 1500 is shown in FIG. 17. The information shown in the further contract screen is the same shown in the further contract screen 500, however, the consultant 20 cannot modify the information. In addition, the further contract screen 1500 includes a payment certificate link 1502 and an add variation link 1504.

One of the responsibilities of the consultant 20 is to certify the value of work performed by the contractors during the project. The consultant 20 submits payment certificates which certify the value of work payable each month. Payment is then effected to the consultant 20 for distribution to the contractors 42. In the event that the amount certified on the payment certificate varies significantly from the budgeted amount by the consultant, the contract manager 24 may require an explanation from the consultant 20 for the variation. The application compares the value on the payment certificate with the projected cash flow for that month of work and will automatically send an e-mail to the contract manager and the consultant advising them that this is outside the +/− parameters set by the contract manager

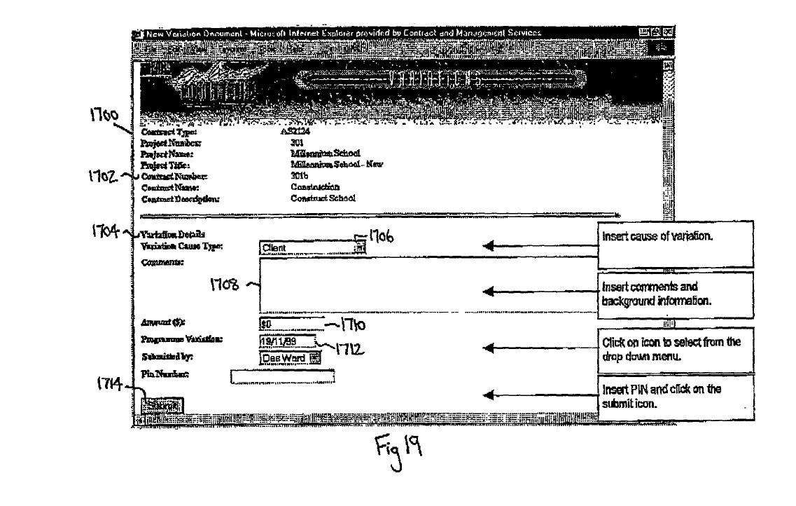

The consultant 20 access a payment certificate by clicking on the payment certificate link 1502, when then presents the consultant 20 with the payment certificate screen 1600 shown in FIG. 18. The payment corticate screen includes contract identification information at 1602, which is automatically inserted by the project control module 30 from the project database 32. Further, the project control module 30 accesses financial information for the project stored in the project database 32 to insert financial summary information concerning the contract. The financial information shown at the summary section of 1604 includes in the original value of the work along with any additions or deductions.

In the event that a bank guarantee from the contractor the subject of the contract does not exist, a retention figure is shown at 1606 corresponding to a certain percentage of the value of the works which is arrived at from the risk management application, or may be specified by the contract manager 24.

The consultant 20 enters the total value of the work performed by the contractor 42 at 1608 and the date that the assessment of the value of the work was made at 1610. Deductions to the value of the work due to defects or liquidated damages are entered at 1612 and 1614 respectively. The amount previously paid to the contractor 42 from previous payment certificates is shown at 1616, with the balance payable shown at 1618.

At 1620 the consultant 20 enters whether the statutory declaration associated with the payment certificate has been received from the contractor 42.

If the amount payment under this payment certificate shown at 1618 varies significantly from the contractor's cash flow estimate entered in the datasheet screen, an explanation for this variation can be entered at 1622. Authorisation for the payment certificate is entered at 1624, and the consultant 20 can submit payment certificate using the submit button 1626. Information contained in the payment certificate screen 1600 is received by the project control module 30 and stored in the project database 32. Information concerning the amount of the payment certificate shown at 1618 is then sent to the accounting software 28 which forwards payment to the consultant 20 for distribution for the contractors.

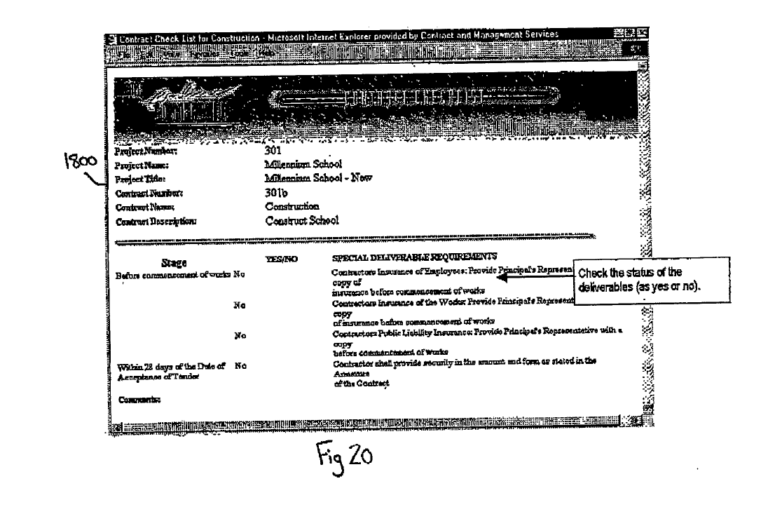

The consultant 20 is also able to submit fee variations for the works performed by the contractor 42 by selecting the add variation link 1604 from the further contract screen 1500. Doing so presents the consultant 20 with a variation screen 1700, which is shown in FIG. 19. The variation screen 1702 and a variation detail section 1704. Information shown in the project information section 1702 is automatically inserted by the project control module 30 from the information in the project database 32.

The consultant 20 enters information concerning the cause of the variation at 1706, a text description of the reason for the variation at 1708, the amount of the variation at 1710, and a revised completion date for the works performed by this contractor at 1712 if applicable. The variation submitted to the contract management 10 by the contractor 20 selecting the submit button 1714. Once the information in the variation screen 1700 is received by the project control module 30, it firstly checks to see whether the value of the variation entered at field 1710 exceeds the value in the consultant approval variation limit field 508 entered in the contract screen 500. If the variation is less than the consultant approval variation field 508, the variation submitted by the consultant 20 using the variation screen 1700 is automatically approved by the project control module 30, when then updates the financial information stored in the project database 32 for the project and notifies the contract manager 24 by email that a variation has been submitted and approved. If the value of the variation entered at field 1710 exceeds the value entered as the consultant approval variation field 508, the project control module 30 sends the variation submitted by the consultant 20 to the contract manager 24 for approval. Upon receiving approval of the variation by the contract manager 24, the project control module 30 updates the financial information stored in the project database 24 for the project.

In addition, the consultant 20 is able to view the list of deliverables to be provided by the contractor by accessing a further contract checklist screen 1800, which is shown in FIG. 20. The information shown in the further contract checklist screen 1800 corresponds with the deliverables designated by the contract manager 24 for the contractor. In this manner, the consultant 20 is able to keep apprised of any outstanding deliverables that are to be provided by contractors under their responsibility.

It should be appreciated that the scope of this invention is not limited to the particular embodiment described above.

I claim

1. In accordance with a first aspect of this invention, there is provided a computer program stored on a computer readable media which, when executed on a computer, performs method steps for managing a contract, said method steps comprising:
storing, for each of a plurality of users, user data including a user-type identifier indicating whether said user is a contract manager or a consultant;
receiving from a contract manager information concerning a project and creating therefrom project data for a project, said project data including an indication of user data for a consultant engaged under contract for the project, deliverables data corresponding to deliverables to be provided under said contract, and financial data for said project;
receiving from the consultant financial data for a project which the consultant is engaged on, and storing said financial data as part of the project data for that project;
receiving from the consultant variations to said financial data for a project which the consultant is engaged on, notifying the contract manager of said variations, and upon receiving authorisation from the contract manager, storing said variations to the financial data in the project data for that project and to authorise payment to the consultant in accordance with the financial data.

2. The computer software of claim 1, wherein the method steps further comprise the step of receiving a fee claim from the consultant, notifying the contract manager of said fee claim, and upon receiving authorisation from the contract manager, approving payment to the consultant.

3. The computer software of claim 2, wherein the method steps further comprise the step of not permitting the consultant to amend the financial data after a payment has been approved, but continuing to allow variations.

4. The computer software of claim 1, wherein said user-type identifier includes a contractor user-type, and said method step of producing project data includes producing an indication of user data for a contractor engaged under contract for the project, deliverables data corresponding to deliverables to be provided under said contract.

5. The computer software of claim 4, wherein the method steps further comprise the step of maintaining at least one insurance due date concerning a consultant and/or contractor relating to said project, sending reminder notices to the contract manager and to the consultant and/or contractor a predetermined time before the expiry of said insurance due dates.

6. The computer software of claim 5, wherein the method steps further comprise the step of rejecting fee claims if any insurance due dates pass.

7. The computer software of claim 1, wherein the method steps further comprise the step of receiving a list of report headings from the contract manager and storing said list in the project data, and upon request from the consultant, presenting a status report to the consultant including the report headings and providing means for the consultant to enter information adjacent each report heading.

8. A contract management system accessible by a plurality of users, comprising:
a data store containing user data and project data, said user data including, for each user, a user-type identifier indicating whether said user is a contract manager, client, clerical support or a consultant;
project control means accessible by a contract manager to create project data for a project, said project data including an indication of user data for a consultant engaged under contract for the project, and deliverables data corresponding to deliverables to be provided under said contract, and financial data for said project;
said project control means being accessible by the consultant to submit financial data for a project which the consultant is engaged on, and to submit variations to said financial data for a said project;
said project control means being further accessible by said contract manager for a project to authorise said variations to the financial data for that project and to authorise payment to the consultant in accordance with the financial data.

9. The contract management system of claim 8, wherein the project control means is arranged to receive a fee claim from the consultant, and in response thereto, to notify the contract manager of said fee claim, and upon receiving authorisation from the contract manager, to approve payment to the consultant.

10. The contract management system of claim 9, wherein the project control means is arranged to not permit the consultant to amend the financial data after a payment has been approved, but to continue to receive variations.

11. The contract management system of claim 8, wherein said user-type identifier includes a contractor user-type, and said project data includes an indication of user data for a contractor engaged under contract for the project, and deliverables data corresponding to deliverables to be provided under said contract.

12. The contract management system of claim 11, wherein said project data includes at least one insurance due date concerning a consultant and/or contractor relating to said project, and said project control means is arranged to send reminder notices to the contract manager and to the consultant and/or contractor a predetermined time before the expiry of said insurance due date.

13. The contract management system of claim 12, wherein the project control means is arranged to reject fee claims from the consultant if any insurance due dates pass.

14. The contract management system of claim 8, wherein the project control means is arranged to receive a list of report headings from the contract manager and store said list in the project data, and upon request from the consultant, to present a status report to the consultant including the report headings and provide means for the consultant to enter information adjacent each report heading.

15. The contract management system of claim 14, wherein the means for the consultant to enter information comprise text entry boxes.

16. The contract management system of claim 15, wherein the project control means is arranged to populate said text entry boxes with information previously submitted by the consultant.
